(19) United States
(12) Patent Application Publication
(10) Pub. No.: US 2007/0024691 A1
(43) Pub. Date: Feb. 1, 2007

(54) Image drum and a manufacturing method thereof

(75) Inventors: Kyu-ho Shin, Seoul (KR); Won-kyoung Choi, Suwon-si (KR); Jong-kwang Kim, Incheon (KR); Kae-dong Back, Yongin-si (KR); Chang-youl Moon, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/397,703

(22) Filed: Apr. 5, 2006

(30) Foreign Application Priority Data
Jul. 29, 2005 (KR) 10-2005-0069220

(51) Int. Cl. B41J 2/39

(52) U.S. Cl. 347/141

(57) ABSTRACT

An image drum and method of producing the same is provided. The drum includes a drum body having a pair of semi-cylindrical members, each being oppositely bonded and having a bonding surface having electrodes being separated from one another by insulating areas, and line electrodes formed on the periphery; a control unit including conductive parts corresponding to the line electrodes, and nonconductive parts interposed between the conductive parts, and disposed inside the drum body; and a connecting member electrically coupling the line electrodes to the control unit. The method includes cutting a cylindrical member into two semi-cylindrical members; oxidizing the surfaces of the members; forming electrodes on each of the cut surfaces; partially oxidizing a substrate; bonding the two semi-cylindrical members across the substrate such that the electrodes and the conductive parts couple together; and forming line electrodes on the periphery of the members.

### CROSS-REFERENCE TO RELATED APPLICATION

This application claims priority under 35 U.S.C. § 119(a) from Korean Patent Application No. 10-2005-0069220, filed Jul. 29, 2005, the entire contents of which are incorporated herein by reference.

### BACKGROUND OF THE INVENTION

1. Field of the Invention

The present invention relates to an image forming apparatus. More particularly, the present invention relates to an image drum used for a direct printing method of an image forming apparatus and a manufacturing method thereof.

2. Description of the Related Art

A direct printing method is a method in which a predetermined drum is directly applied with an image signal, and a latent image is made and developed, and a visible image is formed.

Consequently, there is no need for a light exposing device or a charging device, as is necessary for an electrophotographic method. The direct printing method has a stable characteristic in processing and has been continuously studied. The operational principle of an image drum forming apparatus by a direct printing method is disclosed in EP 0 247 699 A1, and a structure and manufacturing method of image drum are disclosed in EP 0 595 388 A1 and U.S. Pat. No. 6,014,157.

FIG. 1 is a schematic representation illustrating an image forming element disclosed in U.S. Pat. No. 6,014,157.

Referring to FIG. 1, the image forming element includes a cylindrical drum body 1, a plurality of line electrodes 2 formed at a periphery of the drum body 1, and a control unit 3 mounted inside the drum body 1.

The cylindrical drum body 1 is manufactured with aluminum or aluminum alloy.

Each line electrode 2 is insulated from adjacent neighboring electrodes and also insulated from the drum body 1. Furthermore, each line electrode 2 is formed with a through hole (not shown), and the through hole is filled with a conductive material.

The control unit 3 has a terminal, and the terminal and each line electrode 2 are electrically connected by zebra-strip. The control unit 3 applies an appropriate high voltage to each line electrode 2, and the image forming element is formed with a predetermined latent image by the applied high voltage.

However, the image forming element thus described according to the prior art has a disadvantage in that its manufacturing process is complicated and the manufacturing cost is high. The image forming element needs a surface treatment, fine pattern processing by using a laser and E-beam, epoxy and dielectric layer coating, and a coating process by conductive particles.

There is another disadvantage in that multi-stacked PCBs comprising the control unit and drum body are connected by zebra strip by forming a through hole in the drum body. This connection method creates poor bonding power and causes thermal stress, resulting in reliability problems.

### SUMMARY OF THE INVENTION

An aspect of the present invention is to provide an image drum and a manufacturing method thereof configured to simplify the manufacturing process and to save manufacturing cost.

Another aspect of the present invention is to provide an image drum and a manufacturing method thereof configured to improve a connecting structure between a substrate comprising a control unit and a drum body connecting the substrate, thereby improving reliability.

In accordance with an aspect of the present invention, there is provided an image drum comprising a drum body made of a pair of semi-cylindrical members each oppositely bonded and formed at a bonding surface of the semi-cylindrical member with a plurality of mutually insulated electrodes and formed at a periphery thereof with line electrodes in the same gap as that of the electrode; a control unit including conductive parts corresponding to the line electrodes and a nonconductive part interposed between the conductive parts and disposed inside the drum body; and a connecting member electrically connecting each line electrode of the drum body to the substrate of the control unit.

The connecting member may include metal bumps such as solder bumps each formed on the electrode of the semi-cylindrical member and a counter conductive part of the substrate.

Furthermore, the connecting member may be made of anisotropic conductive films each attached to the electrode of the semi-cylindrical member and to a counter portion of the conductive part of the substrate.

The drum body and the substrate may be made of aluminum or aluminum alloy.

The conductive parts and the nonconductive part may be disposed between the conductive parts are formed by partial oxidation of the aluminum substrate.

In accordance with another aspect of the present invention, there is provided a image drum manufacturing method comprising cutting an aluminum cylindrical member into two semi-cylindrical members; oxidizing the surfaces of the two semi-cylindrical members and making same nonconductive; forming a plurality of electrodes on the cut surfaces of the two semi-cylindrical members; partially oxidizing an aluminum substrate to prepare control unit substrates having conductive parts corresponding to the electrodes and nonconductive part interposed between the conductive parts; bonding the two semi-cylindrical members at both sides across the control unit substrates such that the electrodes of semi-cylindrical members and conductive part of the control unit substrate can be coupled; and forming a plurality of line electrodes on the periphery of the semi-cylindrical members in the same gap as that of the electrode.

The bonding the two semi-cylindrical members may be implemented by forming metal bumps thereon such as solder and the like, or by using anisotropic conductive film.

The metal bumps formed on the electrodes and the conductive part may be respectively aligned in two zigzag rows.

Forming the plurality of line elements may further comprise spray-coating photo-resist on the periphery of the mutually bonded semi-cylindrical members; light-exposing the photo-resist using mask, developing and forming a line electrode pattern; and plating a conductive body on the line electrode pattern.

The conductive body may be of Cu, and the plating the conductive body may further comprise gold-treating the conductive body following the Cu plating.

### BRIEF DESCRIPTION OF THE DRAWINGS

The above and other aspects of the present invention will become more apparent by describing in detail exemplary embodiments thereof with reference to the attached drawings, wherein;

FIG. 1 is a perspective view schematically illustrating an image drum according to the prior art;

FIG. 2 is a schematic perspective view of an image drum according to an exemplary embodiment of the present invention;

FIGS. 3A through 3E are manufacturing process drawings of an image drum according to an exemplary embodiment of the present invention;

FIGS. 4A and 4B are respectively a perspective view of a control unit according to an exemplary embodiment of the present invention and a perspective view of the control unit being connected to a drum body;

FIGS. 5A and 5B are schematic exemplary drawings of an electrical connection method between the control unit and the drum body according to an exemplary embodiment of the present invention;

FIG. 6 is an exemplary alignment drawing of metal bumps formed on a conductive part of the control unit and electrodes of the drum body according to an exemplary embodiment of the present invention; and

FIGS. 7A through 7C are process drawings illustrating a method of forming line electrodes on the periphery of the drum body according to an exemplary embodiment of the present invention.

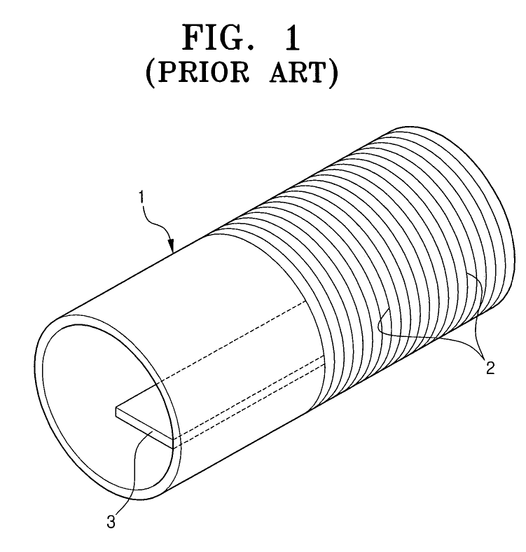

### DETAILED DESCRIPTION OF EXEMPLARY EMBODIMENTS OF THE PRESENT INVENTION

Hereinafter, an exemplary embodiment of the present invention will be described in detail with reference to the accompanying drawings.

In the following description, same drawing reference numerals are used for the same elements even in different drawings. The matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

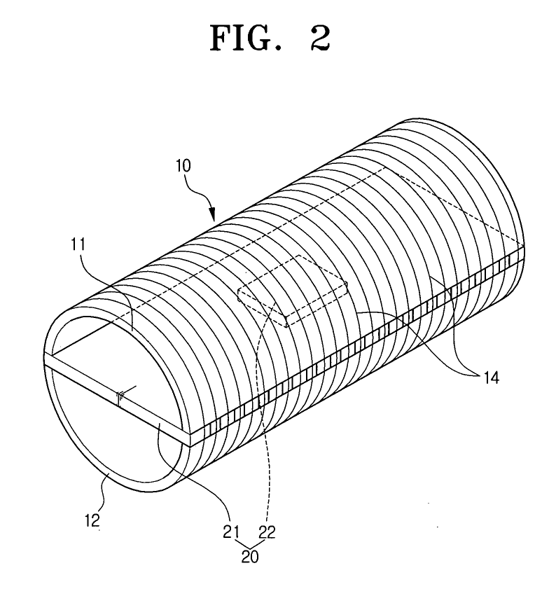

FIG. 2 is a schematic perspective view of an image drum according to an exemplary embodiment of the present invention, wherein reference numeral 10 is a drum body, and 20 is a control unit.

The drum body 10 is constructed in such a manner that a pair of symmetrical semi-cylindrical members 11 and 12 are coupled facing each other.

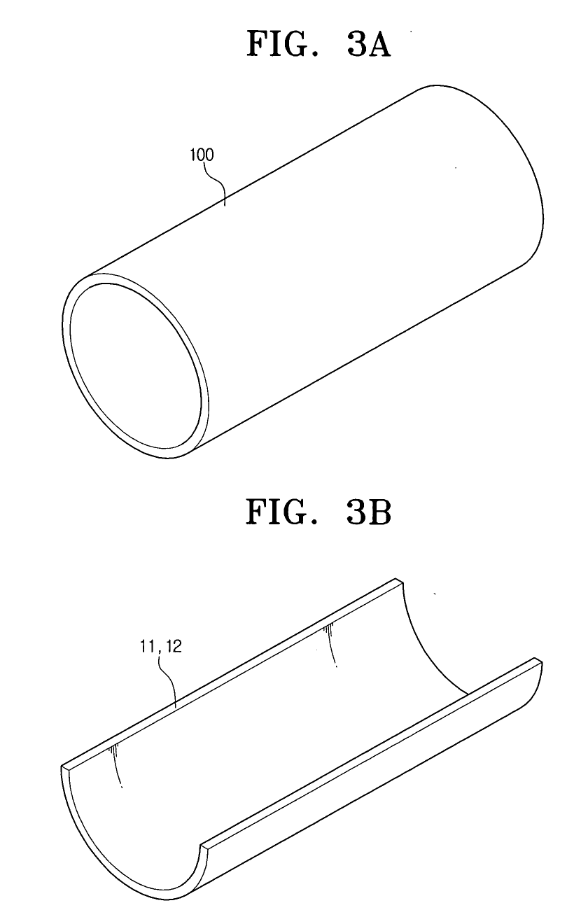

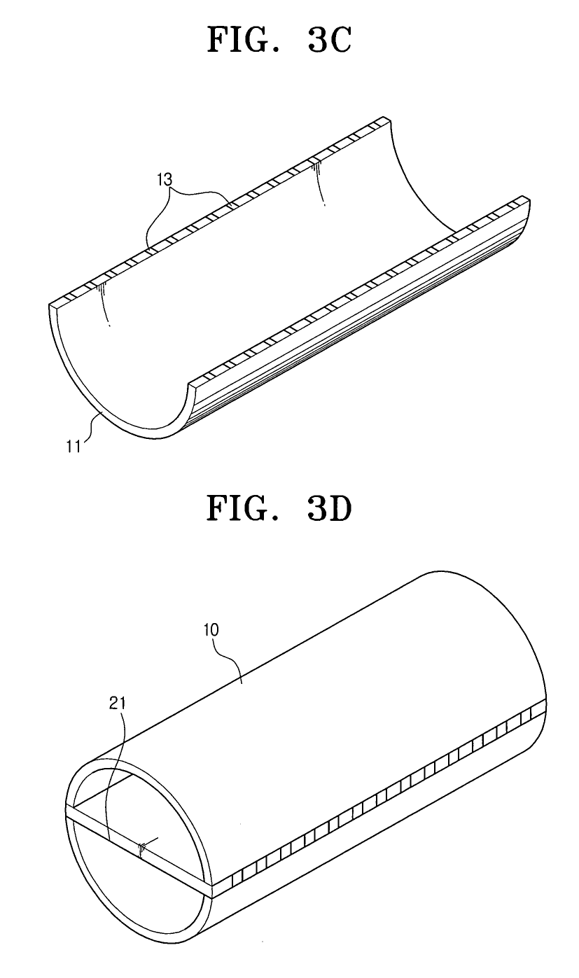

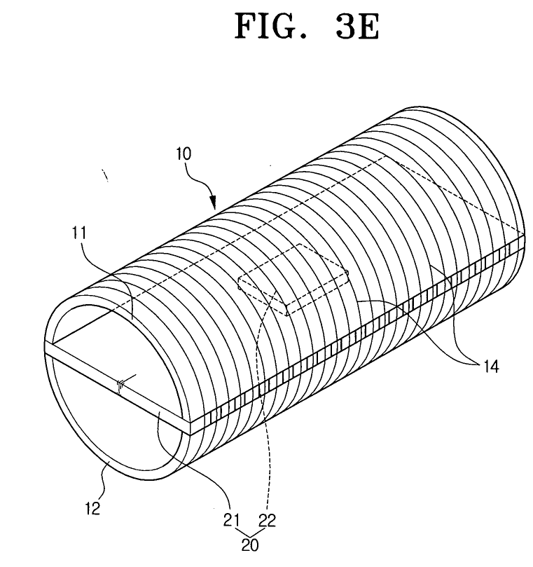

As illustrated in FIGS. 3A through 3E, the pair of semi-cylindrical members 11 and 12 are formed at a coupling surface thereof (identical meaning to ‘cutting surface’ to be described later) with a plurality of electrodes 13.

The electrodes 13 (to be described later in detail) are insulated from each other by the oxidized coupling surface.

Furthermore, the drum body 10 is formed at a periphery thereof with a plurality of electrode lines 14, each spaced a same distance apart as that of the electrodes 13. This distance may be predetermined.

The drum body 10 is made of aluminum or aluminum alloy, or other similar material known in the art.

The diameter, length and pitch of the line electrodes 14 can be appropriately adjusted with regard to a structure or resolution of the image forming apparatus applied thereto.

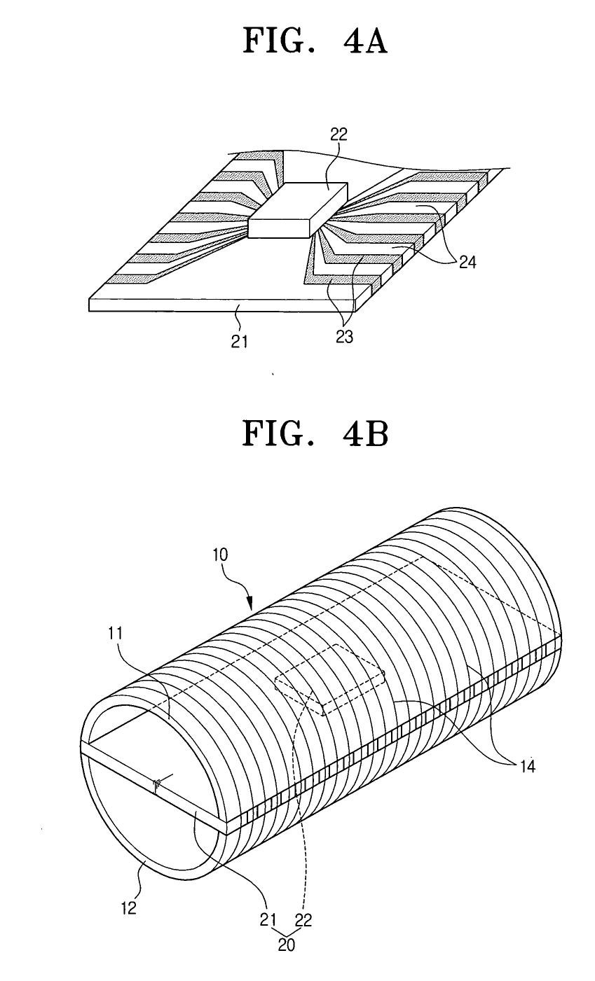

Referring to FIGS. 4A and 4B, the control unit 20 includes a substrate 21 and a chip 22 (for example, an ASIC) packaged to the substrate 21.

The substrate 21 is provided with a plurality of conductive parts 23 corresponding to the electrodes 13 of the semi-cylindrical members 11 and 12, and non-conductive parts 24 interposed between the conductive parts 23. The substrate 21 may be made of aluminum or other similar substrate material known in the art.

The conductive parts 23 are electrically coupled to the electrodes 13, whereby the plurality of line electrodes 14 can be applied with a voltage by the control unit 20. This voltage may be predetermined.

The conductive parts 23 and the non-conductive parts 24 may be simply formed by partially oxidizing the substrate 21.

The drum body 10 and the control unit 20 are assembled in such a manner that both lateral portions of the substrate 21 formed with the conductive parts 23 and the non-conductive parts 24 are coupled by coupling surfaces of the semi-cylindrical members 11 and 12 while both lateral portions of the substrate 21 are inserted between the coupling surfaces of the semi-cylindrical members 11 and 12.

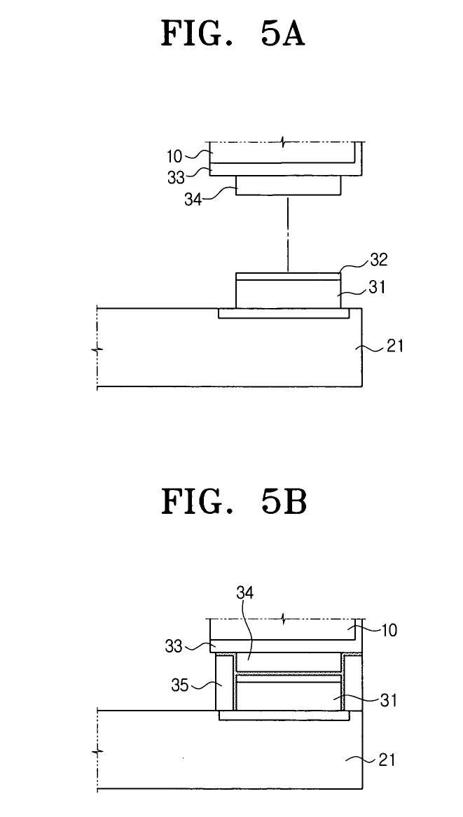

FIGS. 5A and 5B are schematic exemplary drawings of an electrical connection method between the substrate 21 and the drum body 10.

Referring to FIGS. 5A and 5B, the substrate 21 side is stacked with a Cu bump (31) and an Sn layer 32, and the drum body 10 side is stacked with Cu plating layer 33 and a Cu bump 34. The two members are electrically connected by the coupling of the stacked structures and non-conductive paste (NCP) 35 bonding.

Although in the above description a Cu bump is used to connect the conductive parts 23 of the substrate 21 to the electrodes 13 of the drum body 10, it should be apparent that various exemplary modifications are possible. For example, a solder bump may be used or an anisotropic conductive film may be used. The use of a metal bump helps increase the bonding strength and improve the reliability.

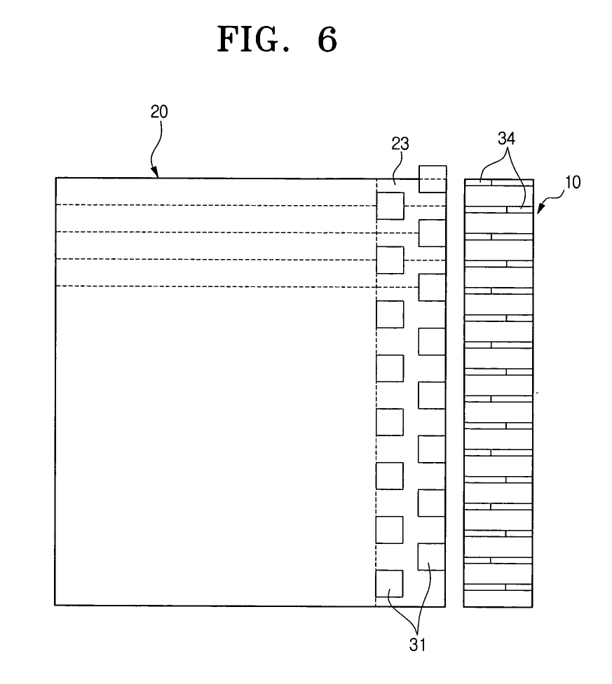

FIG. 6 is an exemplary alignment drawing of metal bumps 31 and 34 formed on a conductive part 23 of the control unit 20 and electrodes 13 of the drum body 10, respectively, according to an exemplary embodiment of the present invention.

Referring to FIG. 6, the metal bumps 31 and 34 are aligned in two zigzag rows. If the metal bumps 31 and 34 are arranged in such a manner, an appropriate pitch between the metal bumps 31 and 34 can be maintained compared with a pitch of a single row alignment, thereby increasing the connection reliability.

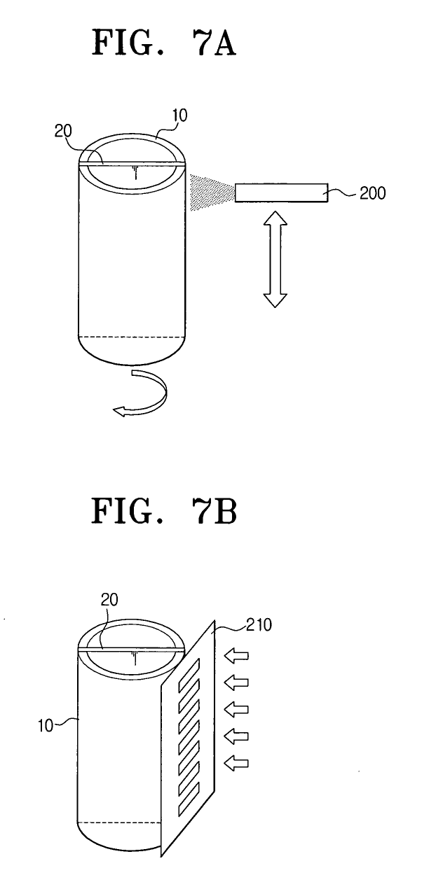

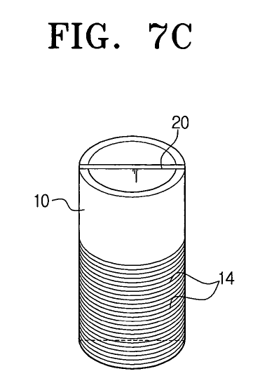

FIGS. 7A through 7C are process drawings illustrating a method of forming a plurality of line electrodes 14 on the periphery of the drum body 10 according to an exemplary embodiment of the present invention.

Referring to FIGS. 3A through 3C, an image drum manufacturing method will be described in detail according to an exemplary embodiment of the present invention.

First, an cylindrical member 100 shown in FIG. 3A is symmetrically cut to prepare a pair of semi-cylindrical members 11 and 12 as shown in FIG. 3B. The cylindrical member 100 may be made of aluminum or other similar material known in the art.

Surfaces of the pair of semi-cylindrical members 11 and 12 are oxidized and made to be non-conductive.

Successively, the cut surfaces of the semi-cylindrical members 11 and 12 are formed with a plurality of electrodes 13 as illustrated in FIG. 3C.

The substrate 21 is partially oxidized and formed with a plurality of conductive parts 23 and a plurality of non-conductive parts 24, and a chip 22 is packaged to the substrate 21 to manufacture a control unit 20 as depicted in FIG. 4A.

Then, as shown in FIG. 3D, the control unit 20 is positioned at the coupling surface of the semi-cylindrical members 11 and 12 to couple the semi-cylindrical members 11 and 12 and assemble the cylindrical drum body 10. Because the conductive part 23 of the substrate 21 and the electrodes 13 of the semi-cylindrical members 11 and 12 are respectively formed with metal bumps, the semi-cylindrical members 11 and 12 and the substrate 21 of the control unit 20 can be solidly coupled.

Now, referring to FIGS. 7A through 7C, the periphery of the drum body 10 is formed with a plurality of line electrodes 14 using a photolithographic process.

The photolithographic process is widely used in such areas as semiconductor process and the like, and there is little difference from the conventional process except that the cylindrical drum body 10 is rotated.

More specifically, in order to form a plurality of line electrodes 14 on the periphery of the drum body 10, the drum body 10 is rotated, and an injector 200 is used to coat photo resist on the surface of the drum body 10 as illustrated in FIG. 7A.

Referring to FIG. 7B, a desired line electrode pattern is formed by processing the light exposure and developing through a photo-mask 210. Here, too, the drum is rotated.

The line electrode pattern is plated with a conductive body, e.g., Cu, or other conductive plating material known in the art, to form the line electrodes 14.

Following Cu plating, Au is used for trimming, the photo-resist is removed, and the manufacturing of the image drum is finished.

As mentioned above, exemplary embodiments of the present invention enable the complicated and accurate process as evidenced in the prior art to be dispensed with, and a reliable and excellent image drum can be manufactured using a simple process.

As apparent from the foregoing, a low-priced image drum can be provided with the simple process.

Furthermore, an electrical connection between the substrate and the drum body is strengthened, and a thermal stress can be minimized due to connection between the aluminum drum body and the aluminum substrate, thereby providing an image drum of high reliability.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An image drum comprising:
a drum body made of a pair of semi-cylindrical members, each of the pair of semi-cylindrical members being oppositely bonded and comprising
a bonding surface having a plurality of electrodes, the plurality of electrodes being separated from one another by a plurality of insulating areas, respectively, and
a plurality of line electrodes formed on the periphery of the semi-cylindrical member in a position corresponding to the plurality of electrodes;
a control unit comprising a plurality of conductive parts corresponding to the plurality of line electrodes and a plurality of nonconductive parts interposed between the plurality of conductive parts, respectively, the control unit being disposed inside the drum body; and
a connecting member electrically coupling each of the plurality of line electrodes of the drum body to the substrate of the control unit.

2. The image drum as defined in claim 1, wherein the connecting member comprises: a plurality of solder bumps, each formed on a corresponding one of the plurality of electrodes and on a corresponding one of the plurality of conductive parts of the substrate.

3. The image drum as defined in claim 1, wherein the connecting member comprises: anisotropic conductive films, each attached to a corresponding one of the plurality of electrodes and to a corresponding one of the plurality of conductive parts of the substrate.

4. The image drum as defined in claim 2, wherein the drum body and the substrate are made of aluminum or aluminum alloy.

5. The image drum as defined in claim 4, wherein the plurality of conductive parts and the plurality of nonconductive parts disposed between the plurality of conductive parts are formed by partial oxidation of the aluminum substrate.

6. An image drum manufacturing method comprising:
cutting a cylindrical member into two semi-cylindrical members;
oxidizing the surfaces of the two semi-cylindrical members and making the surfaces nonconductive;
forming a plurality of electrodes on each respective one of the cut surfaces of the two semi-cylindrical members:
partially oxidizing a substrate to prepare control unit substrates having a plurality of conductive parts corresponding to the plurality of electrodes, and a plurality of nonconductive parts interposed between the plurality of conductive parts, respectively;
bonding the two semi-cylindrical members across the control unit substrates such that the plurality of electrodes of the semi-cylindrical members and the plurality of conductive parts of the control unit substrate correspond to one another and couple together; and
forming a plurality of line electrodes on the periphery of the semi-cylindrical members in a same gap as that of the plurality of electrodes.

7. The method as defined in claim 6, wherein the cylindrical member is made of aluminum.

8. The method as defined in claim 6, wherein the bonding the two semi-cylindrical members comprises forming and bonding solder bumps on each of the plurality of electrodes and each of the plurality of conductive parts.

9. The method as defined in claim 6, wherein the bonding the two semi-cylindrical members comprises respectively attaching and bonding anisotropic conductive films on each of the plurality of electrodes and each of the plurality of conductive parts.

10. The method as defined in claim 8, wherein the solder bumps are respectively aligned in two zigzag rows.

11. The method as defined in claim 6, wherein forming the plurality of line electrodes further comprises:
spray-coating photo-resist on the periphery of the bonded semi-cylindrical members;
light-exposing the photo-resist using a mask to forma a pattern of the plurality of line electrodes; and
plating a conductive body on each of the plurality of line electrodes.

12. The method as defined in claim 11, wherein the conductive body is Cu.

13. The method as defined in claim 12, further comprising gold-treating the conductive body following the Cu plating.
